(19) United States
(12) Patent Application Publication
(10) Pub. No.: US 2014/0048510 A1
(43) Pub. Date: Feb. 20, 2014

(54) CARAFE WITH COOLING ELEMENT

(71) Applicants: Edward Kilduff, New York, NY (US); Shane G. Blomberg, New York, NY (US); Riki Kane Larimer, New York, NY (US)

(72) Inventors: Edward Kilduff, New York, NY (US); Shane G. Blomberg, New York, NY (US); Riki Kane Larimer, New York, NY (US)

(21) Appl. No.: 13/588,349

(22) Filed: Aug. 17, 2012

(51) Int. Cl. B65D 81/18; B23P 15/26; B65D 23/00; F28D 15/00

(52) U.S. Cl. CPC B65D 81/18; F28D 15/00; B23P 15/26; B65D 23/00
USPC 215/387; 165/104.19; 29/890.03

(57) ABSTRACT

A cooling element for use with a carafe that may be used for serving a consumable liquid such as wine. The cooling element can be inserted into the open, upper end of the carafe and the cooling element has as hollow tube that is filled with a cooling agent such as ice, and which extends downwardly into direct contact with the liquid contained within the carafe. There is a passageway that is formed between the cooling element and the carafe that allows the liquid to be poured out of the carafe without removing the cooling element from the carafe. The hollow tube is constructed of a material that has a high thermal conductivity, such as stainless steel, such that the heat exchange is efficient and the heat passes through a single thickness of the heat conductive material.

### BACKGROUND

The present invention relates to a carafe for dispensing a consumable liquid such as wine, that has a cooling element that can be inserted into the carafe to cool the liquid contents of the carafe, and, more particularly, to a wine carafe that has a cooling element having a tube filled with a temperature reducing or cooling agent, such as ice, which cooling element can be inserted into the carafe to directly contact and chill the wine contained therein.

It is known that there are certain liquids, such as white wine, that are intended to be served to a person in a cooled or chilled state for the best flavor and enjoyment. Unfortunately, one of the problems with serving the wine chilled is that the carafe containing the wine generally sits on a table to be accessible to the persons and therefore is not being refrigerated so that the wine eventually warms up to ambient temperature and is no longer served at the proper chilled temperature. Alternatively, the wine carafe can be returned to a refrigerated location each time wine is poured and which is inconvenient to the consumers.

There have been various devices and systems to adjust and maintain wine to be served at a desired, chilled temperature for availability to the wine drinkers, however, many suffer from the lack of good heat conductivity between the cooling agent, and the wine, such that the cooling effect of the cooling agent is very inefficient. Other devices require large containers or cooling devices that are complex and/or bulky and are simply not suitable for use at a table where the wine is being served.

Further devices are known that chill the wine while the wine is in a carafe but require that the chilling device be removed from the wine carafe in order to pour the wine from that carafe. Such devices are likewise, particularly inconvenient for use e.g. at a dinner table.

It would therefore be advantageous to have a device or system to retain the wine at a chilled temperature that is easy to use, provides good efficiency in the use of the cooling effect of the wine and can be inserted and retained in a carafe of wine at the table where the wine is being served, so that chilled wine is can be poured from the carafe without removing the chilling element.

### SUMMARY OF THE INVENTION

Accordingly, the present invention relates to a cooling element and method of installing such cooling element into a carafe in order to chill the liquid contents of the carafe. With the present invention the cooling element comprises an elongated hollow tube that can be filled with a cooling agent, such as ice, and that can be introduced through the upper, open end of a carafe such that the hollow tube can directly contact the liquid contents contained within the carafe.

The cooling element includes a cylindrical outer flange at its upper end. The internal diameter of the cylindrical outer flange is larger than the outer diameter of the elongated hollow tube, and thereby forms and defines an annular recess intermediate the cylindrical outer flange and the elongated hollow tube, which is adapted for reception of the upper open end of the carafe. When the cooling element is fastened onto a carafe, the upper, open end of the carafe enters the annular recess such that the cooling element is retained atop of the carafe.

As such, with the elongated tube directly contacting the liquid within the carafe, there is only a single thickness of material between the cooling agent and the liquid contents of the carafe. In accordance with the present invention, the elongated tube is constructed of a material having a high thermal conductivity, particularly a conductive metal, and, more particularly a non-corrosive, high thermally conductive metal such as stainless steel.

There is a channel formed in the cylindrical outer flange and, as the cooling element is inserted into the upper, open end of the carafe, the spout of the carafe enters into and progresses along that channel while the cooling element is being seated on the upper end of the carafe. A passageway is defined between the channel, the elongated tube and the carafe for the liquid contents of the carafe to reach and be poured from the spout for consumption.

An external, flexible sleeve is positioned so as to surround and releasably engage, the upper, open end of the carafe and the cylindrical outer flange thereby forming a seal therebetween and also serving to aid in the securement of the cooling element onto the carafe, even during the tilting of the carafe to access the contents thereof. With this feature, the liquid contents can be easily poured from the carafe without removing the cooling element from the carafe.

These and other features and advantages of the present invention will become more readily apparent during the following detailed description taken in conjunction with the drawings herein.

### BRIEF DESCRIPTION OF THE DRAWINGS

FIG. 1 is a perspective view of the cooling element constructed in accordance with the present invention, and

FIGS. 2A-2D are perspective views illustrating the steps in a representative method for using the cooling element, by installing the cooling element of FIG. 1 onto a carafe.

FIGS. 3A-3E are perspective views of an alternative illustration of a method for using the cooling element of the present invention, in a sequence with action arrows.

### DETAILED DESCRIPTION OF THE INVENTION

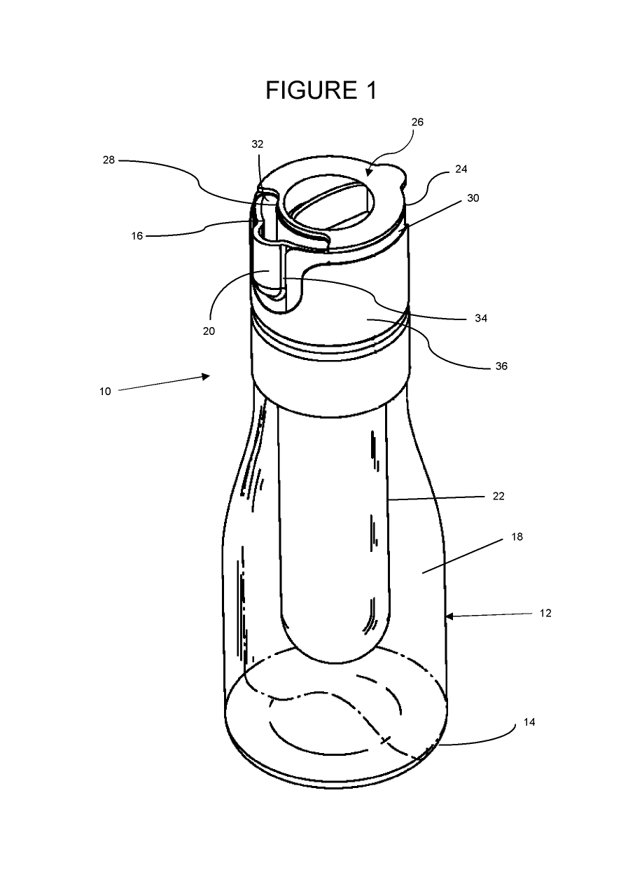

Referring now to FIG. 1, there is shown, a perspective view of the cooling element 10 constructed in accordance with the present invention. As illustrated in this figure, the cooling element 10 is mounted onto a carafe 12. The carafe 12 has a closed bottom 14 and a cylindrical, upper, rim or open end 16, that provides access to a reservoir 18 within the carafe 12 for containing the liquid that is chilled by the cooling element 10. The carafe 12 also has a spout 18 formed in the upper, open end 16 thereof for pouring out the liquid contents from the reservoir 18.

The cooling element 10 includes an elongated, hollow tube 22 that, as can be seen, extends downwardly through the upper, open end 16 of the carafe 12 so as to be in direct contact with any liquid contained within the reservoir 18. The elongated, hollow tube 22 is constructed of a material having a high thermal conductance, preferably a metal and, more preferably, a non-corrosive metal having a high thermal conductivity such as stainless steel.

The upper end 24 of the elongated hollow tube 22 is open such that ice can be loaded into the interior of the hollow tube 22 for cooling purposes. Accordingly, there is only a single thickness of a material between the cooling agent contained within the hollow tube 22 and the liquid contained within the reservoir 18 so that the conductance of thermal values is optimized, particularly so, since the material of the hollow tube 22 has a high thermal conductivity. When the cooling agent has been loaded into the elongated, hollow tube, a cap 26 can be snapped onto the upper end 24 to cover the upper end 24, and is adapted to establish and maintain fluid tight engagement therewith. As can be seen, there is a curved indentation 28 in the cap 26 so that the spout 20 remains uncovered.

The cooling element 10 also has a cylindrical outer flange 30 that has an inner diameter that is larger than the outer diameter of the hollow tube 22, thereby forming an annular recess 32 between the hollow tube 22 and the cylindrical outer flange 30. In the installation of the present cooling element 10 to a carafe 12, the upper, outer end 16 of the carafe 12 fits into the annular recess 32 such that the upper, open end 16 of the carafe 12 is sandwiched therebetween and the cooling element 10 is able to be firmly affixed to the carafe 12, so that, as will be seen herein, the tilting of the carafe 12 to pour the contained liquid, such as wine, from the reservoir 18 does not dislodge the cooling element 10 from the carafe 12, or release the cooling agent into the liquid.

There is a channel 34 that is formed in a vertical orientation in the cylindrical outer flange 30 and, as can be seen in FIG. 1, the spout 20 of the carafe 12 extends through the channel 34 to allow the liquid contents of the reservoir 18 to be poured therefrom in a manner to be later described.

Referring further to FIG. 1, there is a flexible sleeve 36 that encircles the carafe 12 as well as the cylindrical outer flange 30 and serves to form a seal between the cooling element 10 and the carafe 12 as well as to retain the cooling element 10 securely in position to the carafe 12 even when the carafe 12 is tilted for pouring the contained liquid from the reservoir 18. In an exemplary embodiment, the flexible sleeve 36 can be made of a silicone rubber material.

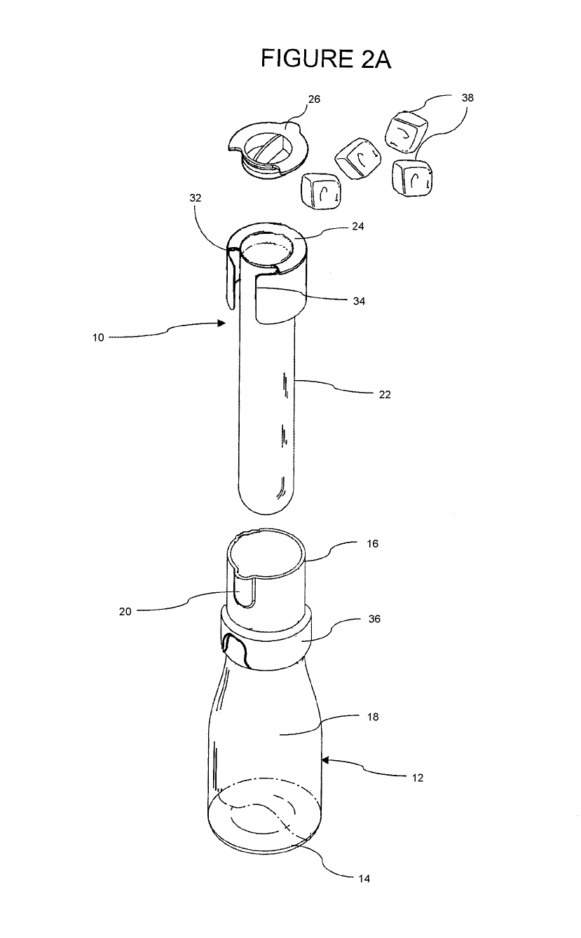

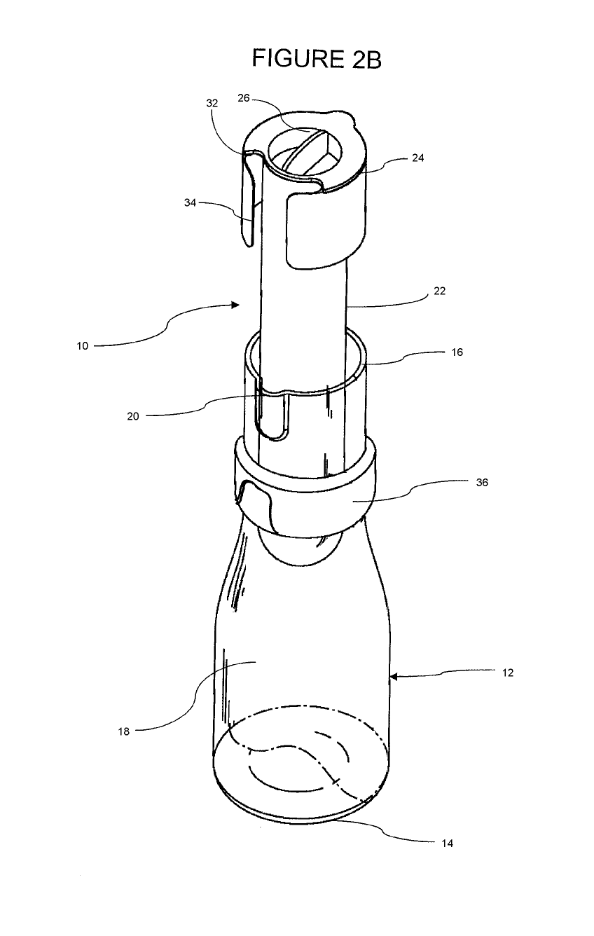

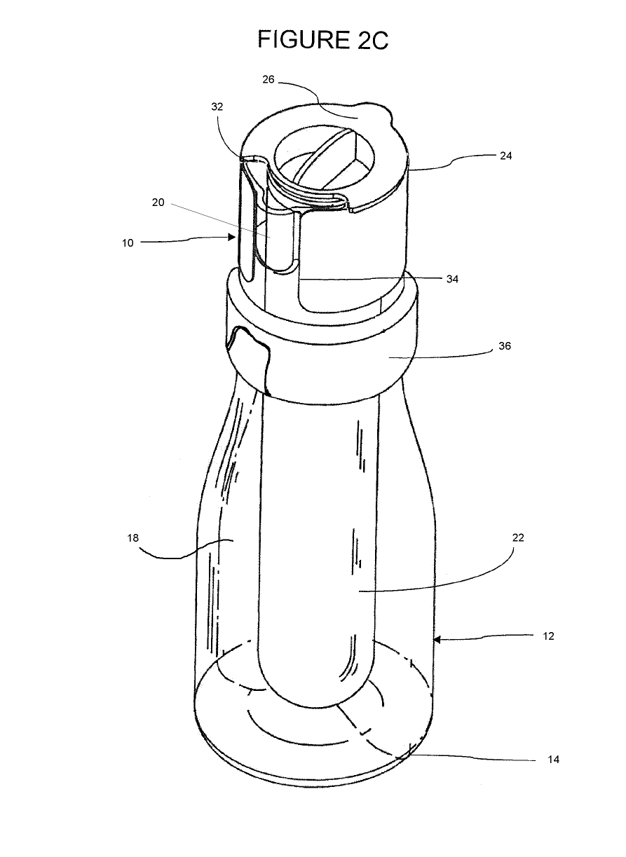

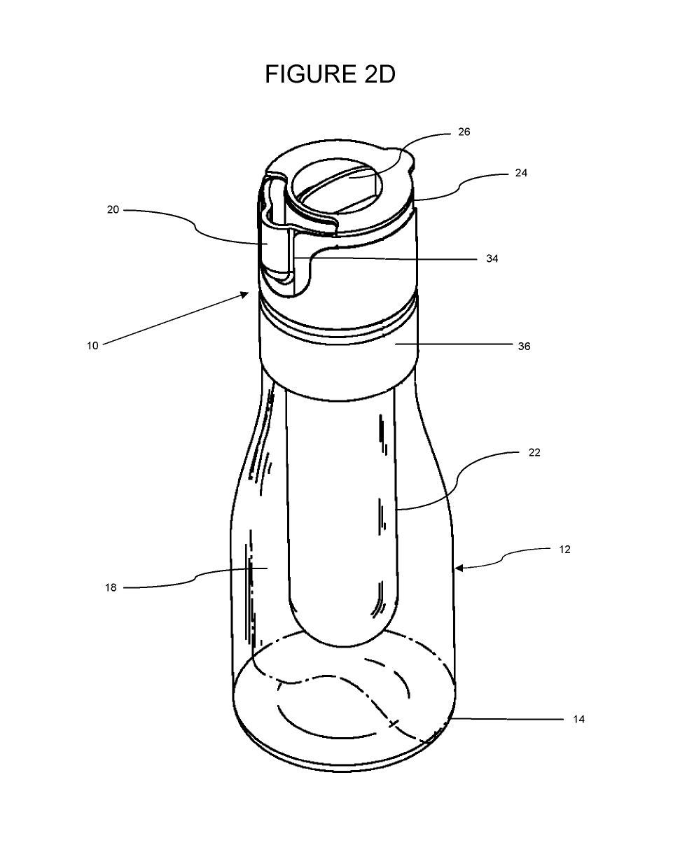

Turning next to FIGS. 2A-2D, perspective views are presented that illustrate a representative sequence of steps that may be taken in the method of securing the cooling element 10 to the carafe 12, including the charging of the cooling element 10 with a cooling agent. Accordingly, in FIG. 2A, the flexible sleeve 36 is positioned on the carafe 12 proximate to the upper, open end 16 of the carafe 12, and is shown folded downwardly and over on itself. The cooling agent, such as ice, labeled 38 is introduced into the interior of the elongated, hollow elongated tube 22, and, when the desired amount of cooling agent 38 fills the hollow tube 22, the cap 26 is snapped over the open, upper end 24 of the hollow tube 22 as previously described, to retain the cooling agent 38 within the hollow tube 22.

In FIG. 2B, it can be seen that the hollow tube 22 is being inserted into the upper, open end 16 of the carafe and is being lowered vertically into the carafe 12. The spout 20 is aligned with the channel 34 in the cylindrical outer flange 30 of cooling element 10. As such, in FIG. 2C, it can be seen that the spout 20 enters and progresses along the channel 34 as the cooling element 10 is lowered into the carafe 12.

Referring further to FIG. 2C, cooling element 10 is seen to be fully inserted into the carafe 10 and the lower portion of the elongated hollow tube 22 is located in the reservoir 18 of the carafe, where it directly contacts the liquid contained therein to allow the cooling agent loaded within the cooling element 10 to chill the contained liquid. Thermal values are transferred from the liquid through the single wall of the hollow tube 22 and the liquid, such as white wine, is chilled by the action of cooling element 10. In this illustration, the flexible sleeve 36 is still in a folded over condition.

Finally, in FIG. 2D, the flexible sleeve 36 is now unrolled upwardly and in the direction of open end 16 of carafe 12 so that it overlaps the cylindrical outer flange 30 of the cooling element 10, forming a good seal therebetween as well as securely affixing the cooling element 10 to the carafe 12 to ensure that the cooling element 10 does not come out of the carafe 12 when it is tilted for pouring the wine from the reservoir 18 through spout 20.

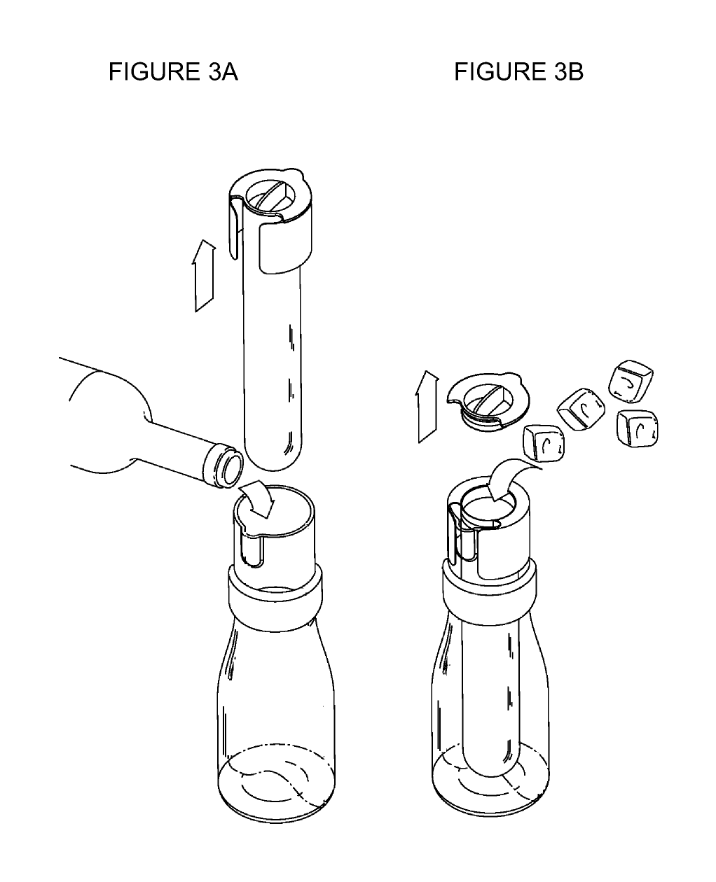

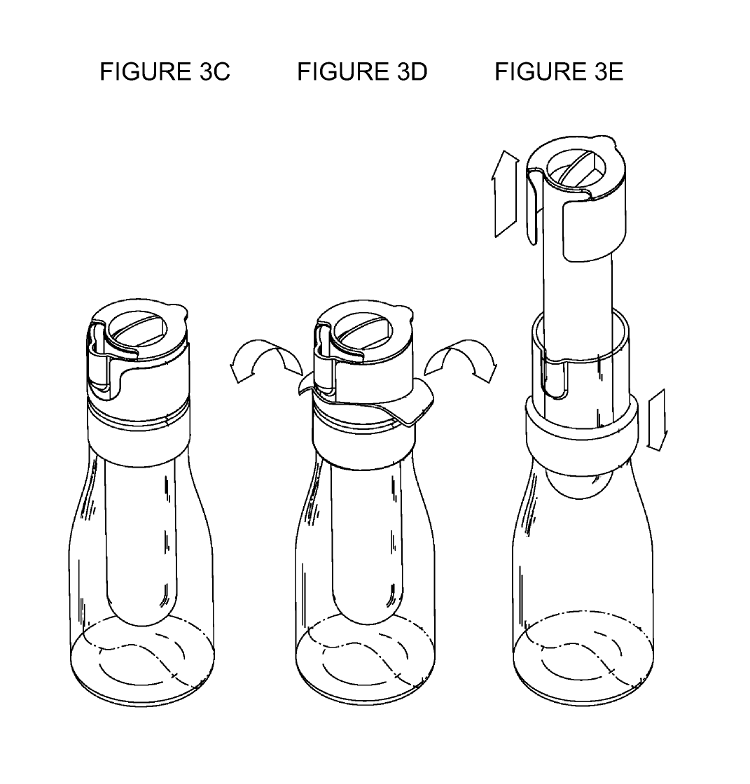

FIGS. 3A-3E illustrate with action arrows, a typical sequence of actions that the user of the cooler element of the invention might go through. Thus, in FIG. 3A, the user would first charge the carafe with a quantity of liquid to be chilled, such as wine. In this step, the cooling element is shown removed from the carafe, by its schematic disposition above the carafe while the liquid is poured into the carafe. In FIG. 3B, the cooling element is introduced into the carafe, and the cap is removed, to permit the charging of the cooling agent, into the interior chamber of the element. As noted earlier, the cooling agent may comprise cubes or granules of a chilled, reduced temperature substance. Representative substances would include ice cubes, ice chips, and cube-shaped solid objects, for example, manufactured from stone or even metal, that are placed in a freezer and maintained therein to reduce their temperature to below the freezing point, and then withdrawn and placed in the cooling element as shown.

In FIG. 3C, the cooling element has been filled to the desired capacity and volume, and the cap is then placed securely into sealing engagement with the top of the cooling element. The flexible sleeve is shown in the extended position and securely engages the outer flange of the cooling element, to maintain the same in fixed position within the carafe, and to thereby facilitate the chilling of the contained liquid.

In FIG. 3D, the liquid has been dispensed and the carafe is readied for recharging of liquid, or for cleaning and storage. In this illustration, the sleeve is folded over on itself in the direction away from the open end or mouth of the carafe, and out of contact and engagement with the cylindrical outer sleeve of the cooling element. This thereby frees the cooling element for withdrawal from the carafe, as illustrated in FIG. 3E. At this point, the carafe may be either recharged with further liquid, and the cooling agent in the cooling element may be replaced or recharged, or both items may be cleaned and stored for future use.

Those skilled in the art will readily recognize numerous adaptations and modifications which can be made to the wine aerator of the present invention which will result in an improved cooling element and method of installing the same onto a carafe for chilling wine, yet all of which will fall within the scope and spirit of the present invention as defined in the following claims Accordingly, the invention is to be limited only by the following claims and their equivalents.

What is claimed is:

1. A cooling element for insertion into the upper, open end of a carafe for containing a liquid, the cooling element comprising a elongated, hollow tube constructed of a material having a high thermal conductivity, the elongated, hollow tube having a cylindrical outer flange forming an annular recess between the elongated, hollow tube and the cylindrical outer flange, the hollow tube adapted to be inserted into the upper, open end of a carafe with the upper, open end of the carafe positioned in the annular recess, a channel formed in the cylindrical outer flange and an external sleeve surrounding the outer flange to form a liquid passageway between a carafe and the channel formed in the cylindrical outer flange.

2. The cooling element of claim 1 wherein the elongated hollow tube has an upper opening and a cap is removable fitted to close the upper opening.

3. The cooling element of claim 1 wherein external sleeve is a flexible material.

4. The cooling element of claim 1 wherein external sleeve is a flexible material.

5. The cooling element of claim 1 wherein the high thermal conductivity material of the hollow tube is a metal.

6. The cooling element of claim 5 wherein the high thermal conductivity material of the hollow tube is stainless steel.

7. A method of assembling a cooling element to a carafe, the cooling element having a hollow tube and a cylindrical flange having an internal diameter larger than the outer diameter of the hollow tube and a vertical channel formed therein and the carafe having an upper open end with a spout, the method comprising the steps of:
affixing a folded over flexible sleeve to the upper, open end of the carafe,
introducing ice into the hollow tube,
inserting the hollow tube into the open end of the carafe to interfit the upper, open end of the carafe into an annular space formed between the internal diameter of the cylindrical flange and the outer diameter of the hollow tube such that the spout of the carafe enters and slides along the vertical channel of the cylindrical flange, and
unfolding the flexible sleeve to encircle both the cooling element and the carafe.

8. The combination of a carafe having a cooling element affixed thereto, the carafe having a reservoir for containing a liquid and an upper, open end having a pouring spout formed in the upper, open end, a cooling element positioned within the upper open end of the carafe for containing a liquid, the cooling element comprising a elongated, hollow tube comprised of a material having a high heat conductivity and extending downwardly into the reservoir of the carafe, the elongated, hollow tube having a cylindrical outer flange forming an annular recess therebetween that sandwiches the upper, open end of the carafe in the annular reservoir, a channel formed in the cylindrical outer flange and an external sleeve surrounding the outer flange to form a liquid passageway between the carafe and the channel formed in the cylindrical outer flange to allow a liquid to pass therethrough from the reservoir through the spout.

9. The combination of claim 8 wherein the elongated, hollow tube has an upper opening and a cap is removable fitted to close the upper opening.

10. The combination of claim 8 wherein the elongated, hollow tube is constructed of a highly thermally conductive material.

11. The combination of claim 10 wherein the highly thermally conductive material is a metal.

12. The combination of claim 10 wherein the highly thermally conductive material is stainless steel.
